(19) United States
(12) Patent Application Publication
(10) Pub. No.: US 2005/0280702 A1
(43) Pub. Date: Dec. 22, 2005

(54) Imaging apparatus

(75) Inventors: Norihiko Nakano, Fujisawa (JP); Tsutomu Usui, Yokohama (JP); Hirotomo Sai, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/114,456

(22) Filed: Apr. 25, 2005

(30) Foreign Application Priority Data
Jun. 17, 2004 (JP) 2004-179143

(51) Int. Cl. H04N 13/00; H04N 15/00

(52) U.S. Cl. 348/42

(57) ABSTRACT

A stereoscopic imaging system includes a stereoscopic imaging apparatus having a plurality of imaging modules to pick up an image and an imaging sync control module to arithmetically process the video signals output from the plurality of the imaging modules for the stereoscopic imaging operation. In the case where the imaging modules control the exposure using an electronic shutter function and come to have different timing of the center of gravity of the exposure period, an imaging sync control module sets the plurality of the imaging modules at the same timing of the center of gravity of the exposure period by displacing the phase of the timing of the center of gravity of the exposure period of the imaging modules thereby to prevent the image processing capability of the stereoscopic imaging operation from being reduced.

### INCORPORATION BY REFERENCE

The present application claims priority from Japanese application JP 2004-179143 filed on Jun. 17, 2004, the content of which is hereby incorporated by reference into this application.

### BACKGROUND OF THE INVENTION

The present invention relates to an imaging apparatus having a plurality of imaging means.

An example of the background art in this technical field is disclosed in JP-A-2002-145072. The subject of this publication is “to provide a railway crossing obstacle detection apparatus capable of detecting an obstacle with high accuracy over a wide range within the crossing” and as a solution, the publication discloses a technique relating to “a railway crossing obstacle detection apparatus comprising at least a pair of left and right cameras 11a, 11b arranged directed to the monitor area within a crossing to acquire the left and right images of the monitor area, and execute the process including a first stage to extract a change portion in one of the left and right images using the unsteady area discrimination method (detecting an image change with a single eye), and a second stage to verify, upon extraction of a change portion, the image of the change portion by the plane projection stereo method using the left and right images thereby to detect an obstacle in the monitor area, the apparatus further comprising a synchronizing means 20 to set the left and right images in phase with each other in the same timing, characterized in that the synchronizing means includes a sync signal generating means 2 for generating a sync signal and delay adjusting means 21a, 21b, and the pair of the left and right cameras are adjusted by the delay adjusting means before use”.

### SUMMARY OF THE INVENTION

In a monitor camera and a stereoscopic camera, a technique for extracting a subject by picking up a stereoscopic image thereof using a plurality of cameras is well known. In the process, it is effective to synchronize a plurality of cameras as shown in FIG. 5A by the method disclosed in JP-A-2002-145072 described above to improve the image processing accuracy.

In view of the fact that the light source, the reflection angle and the imaging angle are different from one camera to another, the illuminance of the subject may be different for each camera. Also, an image may be picked up using different types of cameras having different sensitivities, different optical systems or different imaging periods. In such a case, as shown in FIG. 5B, the exposure is controlled differently for different cameras. In the case where the exposure is controlled using an electronic shutter function as in the camera 2 and the exposure is omitted (the imaging signal is discarded) for the period 5b_2, the synchronization of the image timing (signal output timing) between the cameras leads to different timing of the center of gravity of the exposure period between the cameras. In the stereoscopic imaging, the images picked up by a plurality of cameras are processed by comparative arithmetic operation. In the case where the timing of the center of gravity of the exposure time is different from one camera to another, therefore, the capability of processing the images of a moving subject picked up stereoscopically is reduced (for example, the accuracy of subject extraction is reduced for a lower accuracy of recognition of the size and distance of the subject). This problem often becomes conspicuous especially in the case where the subject moves quickly and the exposure time is often shortened using the electronic shutter (or the mechanical shutter) function to suppress the blur or the out-of-focus state caused by the movement of the subject. In the monitor camera, for example, the monitor capability is reduced by a reduced image processing capability. Even in the case where the illumination difference of the subject is great between the cameras or different types of cameras are used, therefore, it is desirable to make it possible image the subject (a criminal, for example) clearly with a high image quality.

Accordingly, it is an object of this invention to provide an imaging apparatus having a plurality of imaging means to improve the image quality.

According to this invention, there is provided an imaging apparatus comprising a first imaging means, a second imaging means and a control means for controlling the first and/or second imaging means to set the timing of the center of gravity or the center of the exposure time of the first and second imaging means.

This invention can realize an imaging apparatus having a plurality of imaging means which can achieve a high image quality.

### BRIEF DESCRIPTION OF THE DRAWINGS

These and other features, objects and advantages of the present invention will become more apparent from the following description when taken in conjunction with the accompanying drawings wherein:

FIG. 1 is a schematic diagram showing a stereoscopic imaging system according to a first embodiment of the invention;

FIGS. 2A and 2B are diagrams showing an example of the exposure control timing of a stereoscopic imaging system according to the first embodiment of the invention;

FIGS. 3A to 3C are diagrams showing an example of the exposure control timing of a stereoscopic imaging system according to a second embodiment of the invention;

FIGS. 4A and 4B are diagrams showing an example of the exposure control timing of a stereoscopic imaging system according to a third embodiment of the invention; and

FIGS. 5A and 5B are diagrams showing an example of the exposure control timing of a stereoscopic imaging system according to the prior art.

### DETAILED DESCRIPTION OF THE EMBODIMENTS

Embodiments of the invention are described below with reference to the drawings.

### First Embodiment

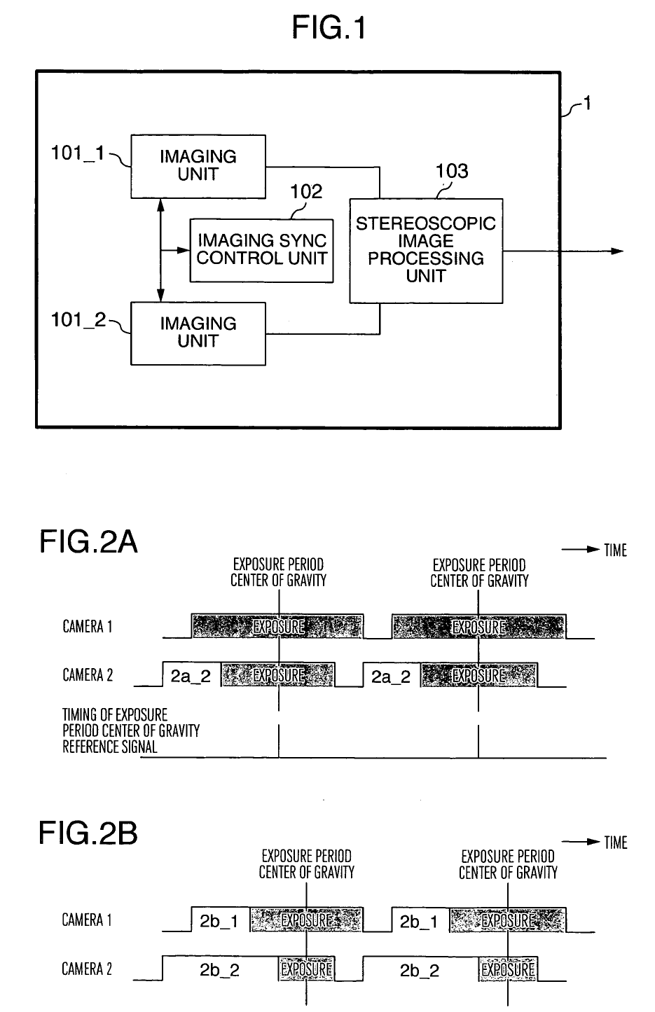

FIG. 1 is a schematic diagram showing a stereoscopic imaging system according to a first embodiment of the invention. In FIG. 1, reference numeral 1 designates a stereoscopic imaging apparatus, numeral 101_1 a first imaging unit, numeral 101_2 a second imaging unit, numeral 102 an imaging sync control unit, and numeral 103 a stereoscopic image processing unit.

In the stereoscopic imaging apparatus 1, the first imaging unit 101_1 picks up an image and outputs a video signal. The second imaging unit 101_2 similarly picks up an image and outputs a video signal. The imaging sync control unit 102 controls the imaging synchronism between the first imaging unit 101_1 and the second imaging unit 101_2. The stereoscopic image processing unit 103 processes the images picked up stereoscopically by executing the process of extracting/recognizing the subject and calculating the distance to and the position of the subject based on triangulation using the video signals output from the first imaging unit 101_1 and the second imaging unit 101_2.

FIGS. 2A and 2B are diagrams showing an example of the exposure control timing of the stereoscopic imaging system according to the first embodiment of the invention. In FIG. 2A, a camera 2 controls the exposure using the electronic shutter function, and in FIG. 2B, both cameras 1 and 2 control the exposure using the electronic shutter function. The camera 1 is equivalent to the first imaging unit 101_1 shown in FIG. 1, and the camera 2 to the second imaging unit 101_2 shown in FIG. 1.

In the stereoscopic imaging system, the synchronization of the imaging timing between a plurality of cameras to control the exposure using the electronic shutter function leads to different timings of the center of gravity of the exposure period as shown in FIG. 5B, thereby posing the problem of a reduced stereoscopic image processing capability. According to this embodiment, as shown in FIG. 2A, the phase of the imaging timing is displaced between the plurality of the cameras, so that the respective cameras can be set to the same timing of the center of gravity of the exposure period. In the stereoscopic image processing unit 103, the stereoscopic image is processed using any of the video signals output from the first imaging unit 101_1 and the second imaging unit 101_2 which has the same timing of the center of gravity of the exposure period.

In order to control the timing of the center of gravity of the exposure period as described above, sync signals of different timings are input to the first imaging unit 101_1 and the second imaging unit 101_2 as the result of the arithmetic operation performed by the imaging sync control unit 102 using the exposure control parameters acquired from the first imaging unit 101_1 and the second imaging unit 101_2. As an alternative, a reference signal for the timing of the center of gravity of exposure is output from the imaging sync control unit 102 to the first imaging unit 101_1 and the second imaging unit 101_2, and the imaging timing is controlled in the first imaging unit 101_1 and the second imaging unit 101_2 in such a manner that the reference signal for the timing of the center of gravity of exposure is synchronized with the timing of the center of gravity of the exposure period as shown in FIG. 2A. In this way, the imaging timing is controlled in each of the imaging units using the reference signal for the timing of the center of gravity of exposure output from the imaging sync control unit 102. As a result, each camera of the stereoscopic imaging system can be set to the same timing of the center of gravity of the exposure period without acquisition of the exposure control state of each imaging unit and the arithmetic operation on the part of the imaging sync control unit 102.

In FIG. 2B, both the cameras 1 and 2 control the exposure using the electronic shutter function. Also in this case, the cameras 1 and 2 can be set to the same timing of the center of gravity of the exposure period by displacing the phase of the imaging timing of the cameras 1 and 2.

As described above, according to this embodiment, in the case where the exposure is controlled using the electronic shutter function, the stereoscopic imaging operation is made possible with a plurality of cameras set to the same timing of the center of gravity of the exposure period by displacing the phase of the imaging timing between the cameras. In this way, the image processing capability of the stereoscopic imaging operation is improved.

### Second Embodiment

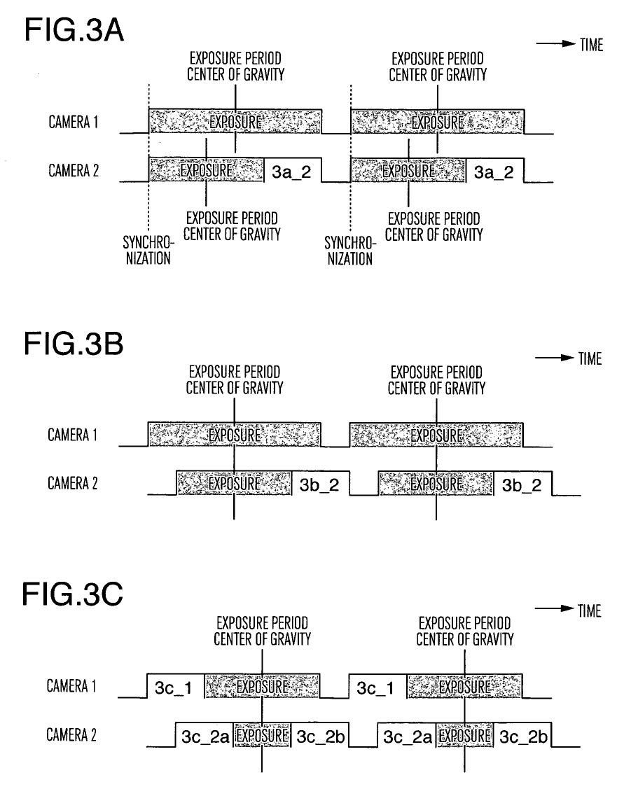

FIGS. 3A to 3C are diagrams showing an example of the exposure control timing of the stereoscopic imaging system according to a second embodiment of the invention. In FIG. 3A, the camera 2 controls the exposure using a mechanical shutter, and so does the camera 2 in FIG. 3B. In FIG. 3C, on the other hand, the camera 1 controls the exposure using the electronic shutter function, while the camera 2 controls the exposure using both the electronic shutter function and the mechanical shutter function. The camera 1 is equivalent to the first imaging unit 101_1 shown in FIG. 1, and the camera 2 to the second imaging unit 101_2 shown in FIG. 1.

In the case where the exposure is controlled using the mechanical shutter in the stereoscopic imaging system, the synchronization of the imaging timing among a plurality of cameras leads to different timings of the center of gravity of the exposure period among the cameras as shown in 3a of FIG. 3, thereby posing the problem of a reduced image processing capability of the stereoscopic imaging operation. According to this embodiment, as shown in 3b of FIG. 3, the phase of the imaging timing is displaced among a plurality of cameras, thereby making it possible to set the respective cameras to the same timing of the center of gravity of the exposure period.

In order to control the timing of the center of gravity of the exposure period in this way, as in the first embodiment of the invention, the imaging sync control unit 102 inputs a sync signal of a different timing to each imaging unit, or a reference signal for the timing of the center of gravity of exposure to each imaging unit which controls the imaging timing in such a manner that the reference signal for the timing of the center of gravity of exposure is synchronized with the timing of the center of gravity of the exposure period.

In FIG. 3C, the camera 1 controls the exposure using the electronic shutter function while the camera 2 controls the exposure using both the electronic shutter function and the mechanical shutter function. Also in this case, by displacing the phase of the imaging timing between the camera 1 and the camera 2, the camera 1 and the camera 2 can be set to the same timing of the center of gravity of the exposure period.

As described above, according to this embodiment, in the case where the exposure is controlled using the mechanical shutter or both the electronic shutter and the mechanical shutter, the phase of the imaging timing is displaced among the cameras. In this way, the stereoscopic imaging operation is made possible in which a plurality of cameras are set to the same timing of the center of gravity of the exposure period for an improved image processing capability of the stereoscopic imaging operation.

### Third Embodiment

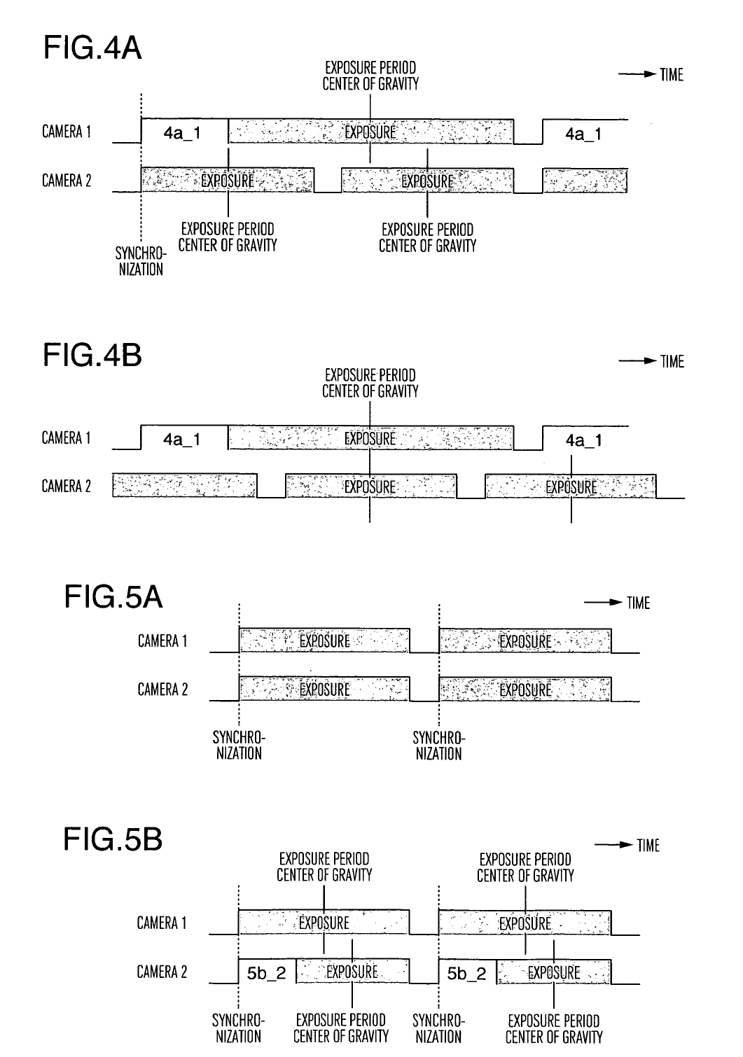

FIGS. 4A and 4B are diagrams showing an example of the exposure control timing of a stereoscopic imaging system according to a third embodiment of the invention. In FIGS. 4A and 4B, the camera 1 and the camera 2 have different imaging periods. The camera 1 is equivalent to the first imaging unit 101_1 shown in FIG. 1, and the camera 2 to the second imaging unit 101_2 shown in FIG. 1.

In this stereoscopic imaging system, the synchronization of the imaging timing among the cameras having different imaging periods leads to different timings of the center of gravity of the exposure period among the cameras as shown in FIG. 4A, thereby posing the problem of a reduced image processing capability of the stereoscopic imaging operation. According to this embodiment, as shown in FIG. 4B, the phase of the imaging timing is displaced among a plurality of cameras, and therefore the respective cameras are set to the same timing of the center of gravity of the exposure period.

In order to set the timing of the center of gravity of the exposure period in this way, as in the first embodiment of the invention, the imaging sync control unit 102 inputs a sync signal of a different timing to each imaging unit, or a reference signal for the timing of the center of gravity of exposure to each imaging unit which controls the imaging timing in such a manner that the reference signal for the timing of the center of gravity of exposure is synchronized with the timing of the center of gravity of the exposure period. Also, the process of synchronizing the timing of the center of gravity of the exposure period described above can be facilitated by employing an integer multiple or integer ratio of the different imaging periods of the cameras.

As described above, according to this embodiment, in the case where the cameras making up a stereoscopic imaging system have different imaging periods, the phase of the imaging timing is displaced among the cameras. In this way, a stereoscopic imaging operation with the same timing of the center of gravity of the exposure period among a plurality of cameras is made possible for an improved image processing capability of the stereoscopic imaging operation.

Although each embodiment has been explained above with reference to a case using two cameras. The number of cameras, however, is not limited to two, but the invention is applicable also to a system in which the images picked up by three or more cameras are subjected to comparative arithmetic operation.

The embodiments are described above in which the timing of the center of gravity of the exposure period is synchronized. As an alternative, the timing of the center of the exposure period can be more simply synchronized. Specifically, the gravity center takes the brightness at each time point in the exposure period into consideration in setting the timing with other cameras (in the case where the first half of the exposure time is bright and the last half thereof dark, for example, the timing is set ahead of the center). However, especially in the case where the exposure period is short, for example, the brightness change during the exposure period is considered small, and the center of the exposure period can be set as a timing with other cameras. In such a case, the circuit configuration is simplified.

This invention is applicable to the monitor camera and the stereoscopic camera.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications a fall within the ambit of the appended claims.

1. An imaging apparatus comprising:
a first imaging module;
a second imaging module; and
a control module to control at least selected one of the first imaging module and the second imaging module and set the first imaging module and the second imaging module at a same timing of selected one of a center of gravity and a center of an exposure period.

2. An imaging apparatus comprising:
a plurality of different imaging modules; and
a control module to control the plurality of the imaging modules and to set the plurality of the imaging modules at a same timing of selected one of a center of gravity and a center of an exposure period.

3. An imaging apparatus comprising:
a plurality of imaging modules;
an imaging sync control module to control the timing of the output signals of the plurality of the imaging modules; and
a stereoscopic image processing module to perform a stereoscopic imaging arithmetic operation against video signals output from the plurality of the imaging modules;
wherein the imaging sync control module displaces a phase of the signal output timing of the plurality of the imaging modules and sets the plurality of the imaging modules to a same timing of a center of gravity of an exposure period.

4. An imaging apparatus according to claim 1,
wherein the imaging module has the electronic shutter function; and
wherein in the case where the timing of the center of gravity of the exposure periods of the plurality of the imaging modules are differentiated by the exposure control operation using the electronic shutter function, the imaging sync control module displaces the phase of the output signals of the plurality of the imaging modules from each other thereby to set the plurality of the imaging modules to the same timing of the center of gravity of the exposure period.

5. An imaging apparatus according to claim 2,
wherein each imaging module has the electronic shutter function; and
wherein in the case where the exposure control operation using the electronic shutter function differentiates the timing of the center of gravity of the exposure periods among the plurality of the imaging modules, the imaging sync control module displaces the phase of the output signals of the plurality of the imaging module from each other thereby to set the plurality of the imaging modules to the same timing of the center of gravity of the exposure period.

6. An imaging apparatus according to claim 3,
wherein each imaging module has the electronic shutter function; and
wherein in the case where the exposure control operation using the electronic shutter function differentiates the timing of the center of gravity of the exposure periods among the plurality of the imaging modules, the imaging sync control module displaces the phase of the output signals of the plurality of the imaging modules from each other thereby to set the plurality of the imaging modules at the same timing of the center of gravity of the exposure period.

7. An imaging apparatus according to claim 1,
wherein each imaging module includes a mechanical shutter; and
wherein in the case where the exposure control operation using the mechanical shutter differentiates the timing of the center of gravity of the exposure period among the plurality of the imaging modules, the imaging sync control module displaces the phase of the output signals of the plurality of the imaging modules from each other thereby to set the plurality of the imaging modules at the same timing of the center of gravity of the exposure period.

8. An imaging apparatus according to claim 2,
wherein each imaging module includes a mechanical shutter; and
wherein in the case where the exposure control operation using the mechanical shutter differentiates the timing of the center of gravity of the exposure periods among the plurality of the imaging modules, the imaging sync control module displaces the phase of the output signals of the plurality of the imaging modules from each other thereby to set the plurality of the imaging modules at the same timing of the center of gravity of the exposure period.

9. An imaging apparatus according to claim 3,
wherein each imaging module includes a mechanical shutter; and
wherein in the case where the exposure control operation using the mechanical shutter differentiates the timing of the center of gravity of the exposure periods among the plurality of the imaging modules, the imaging sync control module displaces the phase of the output signals of the plurality of the imaging modules from each other thereby to set the plurality of the imaging modules at the same timing of the center of gravity of the exposure period.

10. An imaging apparatus comprising:
a plurality of imaging modules having different imaging periods;
an imaging sync control module to control output signals of the plurality of the imaging modules; and
a stereoscopic image processing module to arithmetically process video signals output from the plurality of the imaging modules for a stereoscopic imaging operation;
wherein the imaging sync control module displaces a phase of the output signals of the plurality of the imaging modules thereby to set the plurality of the imaging modules at a timing of a center of gravity of an exposure period.

11. An imaging apparatus according to claim 10,
wherein the imaging sync control module controls the plurality of the imaging modules in such a manner that the timing of the center of gravity of the short imaging period of the imaging modules to the timing of the center of gravity of the long imaging period of the imaging modules having a long imaging period.

12. An imaging apparatus according to claim 1,
wherein the imaging sync control module is supplied with the information on the imaging period from the plurality of the imaging modules, and generates and outputs to each imaging module a sync signal of each imaging module in such a manner that the plurality of the imaging modules are set at the same timing of the center of gravity of the exposure period; and
wherein each of the imaging modules picks up an image in synchronism with the sync signal.

13. An imaging apparatus according to claim 2,
wherein the imaging sync control module is supplied with the information on the imaging period from the plurality of the imaging modules, and generates and outputs to each imaging module a sync signal of each imaging module in such a manner that the plurality of the imaging modules are set at the same timing of the center of gravity of the exposure period; and
wherein each of the imaging modules picks up an image in synchronism with the sync signal.

14. An imaging apparatus according to claim 3,
wherein the imaging sync control module is supplied with the information on the imaging period from the plurality of the imaging modules, and generates and outputs to each imaging module a sync signal of each imaging module in such a manner that the plurality of the imaging modules are set at the same timing of the center of gravity of the exposure period; and
wherein each of the imaging modules picks up an image in synchronism with the sync signal.

15. An imaging apparatus according to claim 1,
wherein the imaging sync control module is supplied with the information on the imaging period from the plurality of the imaging modules, and generates and outputs to the plurality of the imaging modules a reference signal used by each of the imaging modules as a reference to determine the timing of the center of gravity of the exposure period; and
wherein the plurality of the imaging modules are controlled in such a manner as to set the timing of the center of gravity of the exposure period to the reference signal.

16. An imaging apparatus according to claim 2,
wherein the imaging sync control module is supplied with the information on the imaging period from the plurality of the imaging modules, and generates and outputs to the plurality of the imaging modules a reference signal used as a reference to determine the timing of the center of gravity of the exposure period; and
wherein the plurality of the imaging modules are controlled in such a manner as to set the timing of the center of gravity of the exposure period to the reference signal.

17. An imaging apparatus according to claim 3,
wherein the imaging sync control module is supplied with the information on the imaging period from the plurality of the imaging modules, and generates and outputs to the plurality of the imaging modules a reference signal used as a reference to determine the timing of the center of gravity of the exposure period; and
wherein the plurality of the imaging modules are controlled in such a manner as to set the timing of the center of gravity of the exposure period to the reference signal.
